(19) United States
(12) Patent Application Publication
(10) Pub. No.: US 2003/0074322 A1
(43) Pub. Date: Apr. 17, 2003

(54) Peer-to-peer digital copyright management method and system

(75) Inventor: Yi-Lin Wu, Taipei (TW)

Correspondence Address: LOWE HAUPTMAN GOPSTEIN GILMAN & BERNER, LLP, Suite 310, 1700 Diagonal Road, Alexandria, VA, 22314, US

(73) Assignee: Siriuz. Com Ltd.

(21) Appl. No.: 10/029,873

(22) Filed: Dec. 31, 2001

(30) Foreign Application Priority Data
Oct. 17, 2001 (TW) 90125724

(51) Int. Cl. G06F 17/60

(52) U.S. Cl. 705/57

(57) ABSTRACT

A peer-to-peer digital copyright management method and system are disclosed. The invention uses a network with a peer-to-peer connection structure. Each workstation has equivalent abilities and responsibilities. This style is distinguished from the client/server structure, where some computers are assigned to service other computers. In general, the peer-to-peer network is simpler. It does not need to be equivalent to the strong execution abilities and bandwidths of the client/server network. However, it has the drawback of being hard to manage. The invention combines all advantages of the peer-to-peer network platform and the client/server structure. In addition to providing a search share system, which can peer-to-peer rapidly distribute digital contents, it further provides an effective copyright management system which strictly controls file sharing and downloads. Network service points or equivalent currencies for each shared file download are accurately obtained from the download user. In each transaction, the profit is paid to the copyright owner, the download resource and bandwidth provider and the platform service provider. This does not only accelerate the distribution of digital contents, lowers the user's cost in obtaining needed software, but also protects the intelligence properties (IP) of the copyright owners.

### BACKGROUND OF THE INVENTION

1. Field of Invention

The invention relates to a copyright management method and system and, in particular, to a peer-to-peer digital copyright management method and system.

2. Related Art

With the rapid development in digital technologies, a digital information era is coming and rapidly integrated into our life. In contrast to traditional data processing apparatuses that require higher costs, using digital techniques to process data makes the transfer, copy and storage of data much easier and faster without signal attenuation and noises. Original data can be arbitrarily and accurately copied, transmitted and stored in a simple way and at a cheaper price. Currently, CD-ROM's, DVD-ROM's, MD's, digital tapes, HDD's (Hard Disk Drive) and static memory are different important types of digital information storage carriers. The digital data processing devices using the above-mentioned data storage carriers, such as digital walkmans, digital cameras, DVD players, CD players, CD-RW players, mobile phones, PC's (Personal Computer) and all sorts of digital devices derived from the PC's are widely used due to the advance in techniques and the decrease in prices.

Since the digital devices and the digital carriers are fairly cheap nowadays and have the advantage of higher reliability in data processing, any person at any place can use a digital device to communicate with another party at an arbitrary endpoint of a network 24 hours a day, transmitting and sharing files of digitized data, music, e-books, videos, pictures and cartoons. This behavior has gradually become a way of distributing digital data. This kind of connection method is the so-called peer-to-peer network connection.

In spite of the fact that the peer-to-peer data distribution method is cheap and convenient and the data can be rapidly distributed to even the Globe, it is, however, a pity that the peer-to-peer network connection is not as easy in centralized control as in the client/server network connection. This immediately causes illegal duplications and uses of digital IP (Intelligence Property). This does not only infringe the rights of inventors, but also makes people less willing to make innovative inventions.

The conventional invention distribution method is through the marketing and packaging of layers of agents in the industry before it is presented to the consumers. These layers of marketing and packaging inevitably increase the prices of the products, which are eventually shared or supported by consumers. As digital technologies become popular, illicit companies and consumers may use cheap digital data processing devices and carriers to duplicate contents of the invention in a large amount quickly but at a low cost. Without paying the invention and marketing costs, pirating IP becomes more and more popular. This does not only have a great impact on the profits of the inventors and the contents industry, it also raises various kinds of litigations and discussions by countries all over the world.

Some contents industry companies invest and build their own websites to provide a legal way for consumers to download the serviced contents, in the hope to lower the costs in marketing and packaging and simultaneously to increase the competition in the prices of authentic products. Nevertheless, due to the lack of an effective digital copyright management mechanism, most merchants are afraid that they cannot control the distribution of digital files and thus hesitate to provide fill services online. They merely use some non-mainstream products to test the taste of the market and consumers.

Since most of the digital products in music, publications, movies, cartoons and comics are in multimedia formats, each of them is stored in a file with a considerably huge size. Using the client/server network structure to keep the digital files on a website for consumers to download requires a higher cost in apparatuses and maintenance. Moreover, such a setup will never satisfy consumers' demand in bandwidths. The cost in network bandwidths of multimedia transmissions is always expensive. Therefore, many contents industry companies or multimedia industries cannot establish their own dedicated websites to sell their digital products due to the higher costs and thus fewer profits. They are then forced to sell their products through conventional marketing strategies and channels.

In summary, as long as the inventors and consumers are separated far apart due to extra costs imposed from layers of marketing and channels, the consumers cannot obtain desired digital media without paying at a higher expense. This phenomenon forces the consumers to turn to cheaper digital data processing devices and carriers and to illegally obtain the digitized IP's. The appearance of pirate versions does not only have great impacts on the profits of the inventors and the contents industry, it further affects the inventors' will of innovation and investments from the contents industry. On the other hand, due to the lack of an appropriate digital copyright management mechanism, the contents industry companies are afraid of setting up a committed website for consumers to legally download their products. Facing the high costs and wide bandwidth requirements, the direct sale through devoted websites still cannot lower the distribution costs of the genuine products. It is thus highly desirable to have a copyright management system which requires only a low bandwidth to lower the costs and to increase the competitive power of the digital contents industry.

### SUMMARY OF THE INVENTION

In view of the existing problems mentioned in the background, it is an objective of the invention to solve the copyright control and management problems in duplicating and distributing genuine digital creations. Another objective of the invention is to utilize computer devices to provide a copyright control and management mechanism, so that the downloads and distributions of the genuine creations can be more effectively controlled. This allows inventors to obtain their profits.

Anther objective of the invention is to provide an effective way of distributing multimedia files, avoiding the bottleneck in download bandwidth. Through the copyright control and management mechanism, it is possible to implement real-time, error-tolerant file distributions. In particular, it can solve the problem of network jam due to downloading hot files by users.

A further objective of the invention is to provide a low-cost creation distribution platform, which allows any person to present his or her own ideas without worrying about the financial or commercial problems while maintaining the advantages of copyright control and management and rapid file distributions.

According to the above objectives, the invention provides a peer-to-peer copyright management system. First, a copyright management system is installed on a digital processing device of a copyright owner. Using the operating power of the copyright management system and the digital processing device, digital files are computed to generate file fingerprints. Through the networking abilities of the copyright management system and the digital processing device, they are connected to a copyright database provided by a platform service provider. When the digital files are registered and ready for sale, at least the member account of the copyright owner, the file fingerprints, the filenames, and the price information are uploaded to the copyright database.

In addition, a search sharing system is installed on the digital processing devices of the file provider and a consumer. A data sharing area is partitioned in the digital processing device to store shared digital files. Using the operating power of the search sharing system and the digital processing device, the digital files are computed to generate their own file fingerprints. When the search sharing system starts, at least the member account of the file provider, the file fingerprints, and the filenames are uploaded to the copyright database to compare with the registered information of the copyright owner. This forms a real-time correspondence database of files, the copyright owner, and the file provider. The downloader can use the networking abilities of the search sharing system and the digital processing device to connect to the copyright database. At a keyword for searching the digital files is uploaded. After the inquiry is done, the copyright database returns a list of result satisfying the keyword for the consumer to select. A peer-to-peer network connection is then established using the network abilities of the search sharing system and the digital processing device of the consumer and the file provider for downloading the digital files. After the download is complete, the network points of the consumer in the copyright database are immediately deducted in the transaction. These deducted points are distributed to the member accounts of the copyright owner, the file provider, and the platform service provider according to some predetermined proportion.

Moreover, the invention provides a structure of withdrawing and blocking the copyright. For the copyright withdrawal, the copyright owner can withdraw a previously registered digital file without further sharing through the withdrawal function. For the copyright blocking, a block table is used to store all digital file fingerprints that are not to be distributed. Before the search sharing system is started for searching, sharing and downloading, this block table is called to forbid the distribution of digital files without the permission of the inventor or the copyright owner.

### BRIEF DESCRIPTION OF THE DRAWINGS

The present invention will become more fully understood from the detailed description given hereinbelow illustration only, and thus are not limitative of the present invention, and wherein:

FIG. 1 is a schematic flowchart of the disclosed peer-to-peer digital copyright system;

FIG. 2 is a schematic view that describes detailed digital file registration procedure, showing the interactions between the copyright owner and the platform service provider;

FIG. 3 is a schematic view that illustrates how an interested consumer would search for digital files, showing the interactions between the consumer and the platform service provider;

FIG. 4 is a schematic view that illustrates the download method after the consumer finds desired digital files, showing the interactions among the consumer, the file provider and the platform service provider; and

FIG. 5 is a schematic view of the network points allotment management structure in the digital copyright management system.

### DETAILED DESCRIPTION OF THE INVENTION

The present invention will be apparent from the following detailed description, which proceeds with reference to the accompanying drawings, wherein the same references relate to the same elements.

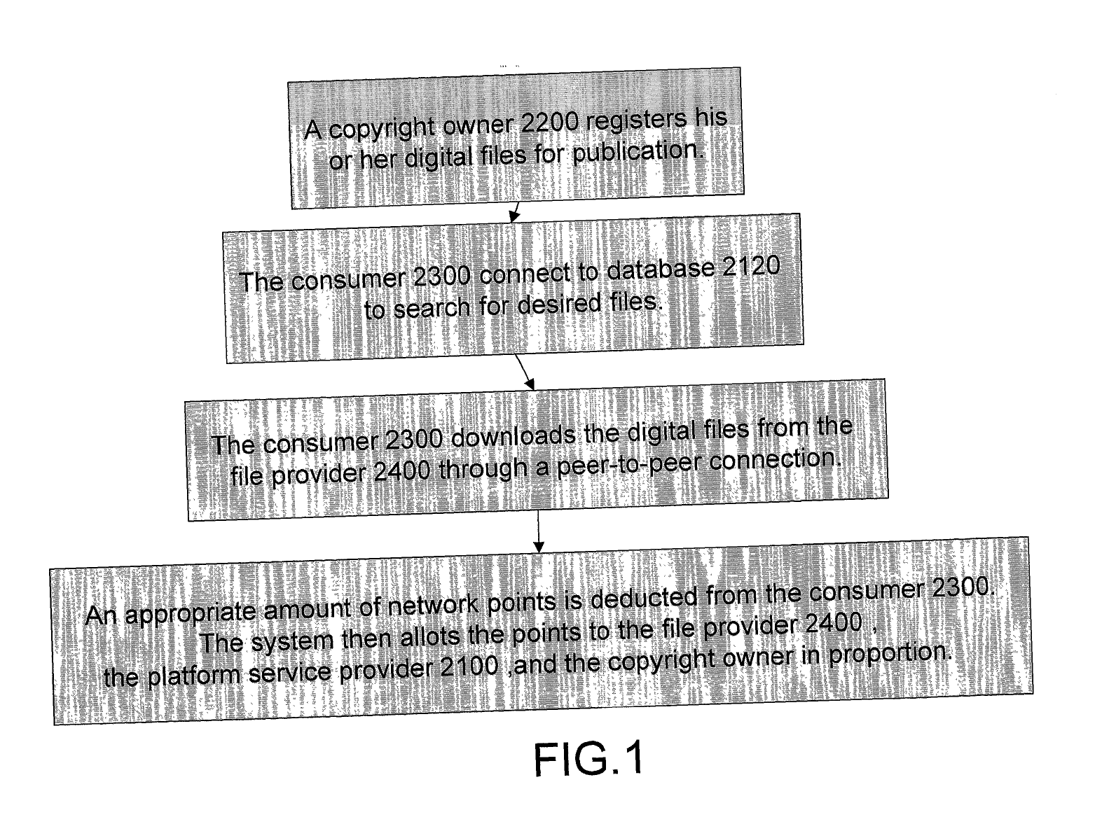

With reference to FIG. 1, according to the procedure of the invention a copyright owner 2200 registers his or her digital files for publication to draw consumer's interests. If an interested consumer wants to purchase some digital files, the consumer is a downloader. The downloader downloads the digital files from the copyright owner 2200 or a platform service provider 2100 through a peer-to-peer connection. Once the file download is complete, an appropriate amount of network points is deducted from the downloader. The system then allots the points to the file provider, the platform service provider 2100, and the copyright owner 2200 in proportion.

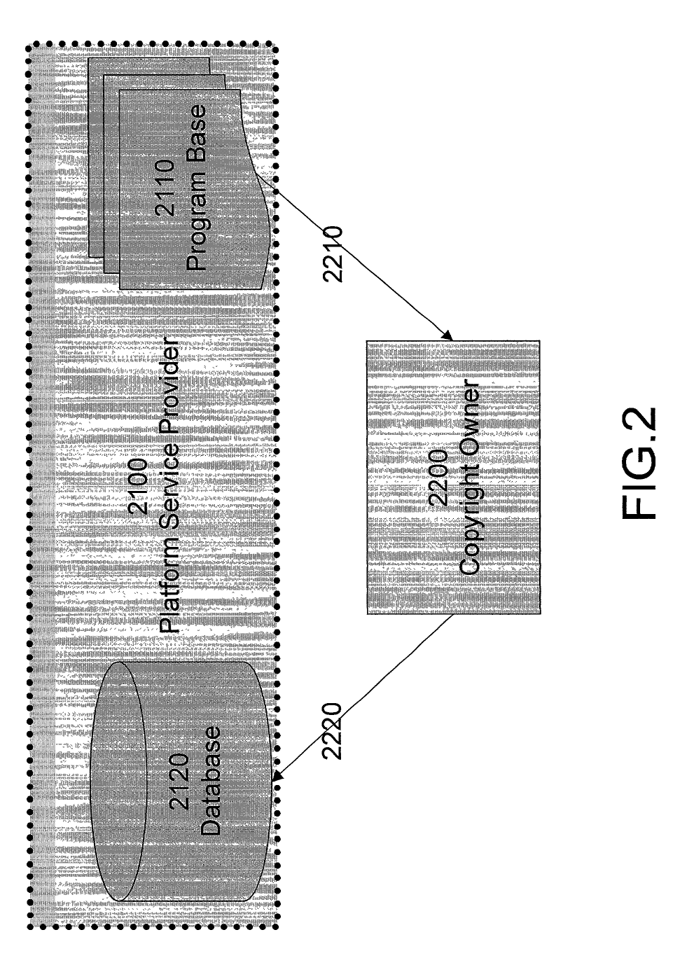

As shown in FIG. 2, the copyright owner 2200 uses a computer and related network devices to connect to the platform service provider 2100. The copyright owner 2200 has to download and install a copyright management system from a program base 2110 of the platform service provider 2100 for the first time (step 2210). After the installation, the copyright owner 2200 can use the copyright management system to register his or her digital files in a database 2120 of the platform service provider 2100 (step 2220). They are then allowed for interested consumers to browse, search and download.

MD5 (Message-Digest) is an algorithm for compress information. MD % accepts string inputs of arbitrary lengths. For such an input string, a set of 128-bit fingerprint is generated. In principle, it is impossible to find the same output fingerprint for two sets of different input strings. Through this type of algorithm, the copyright management system first uses a computing machine such as a computer to convert the digital file that the copyright owner 2200 wants to register into a set of file fingerprint. This file fingerprint along with the account name, password, filename, file and price set by the copyright owner 2200 is uploaded to the database 2120 of the platform service provider 2100 for searches. This completes the registration procedure of the digital file.

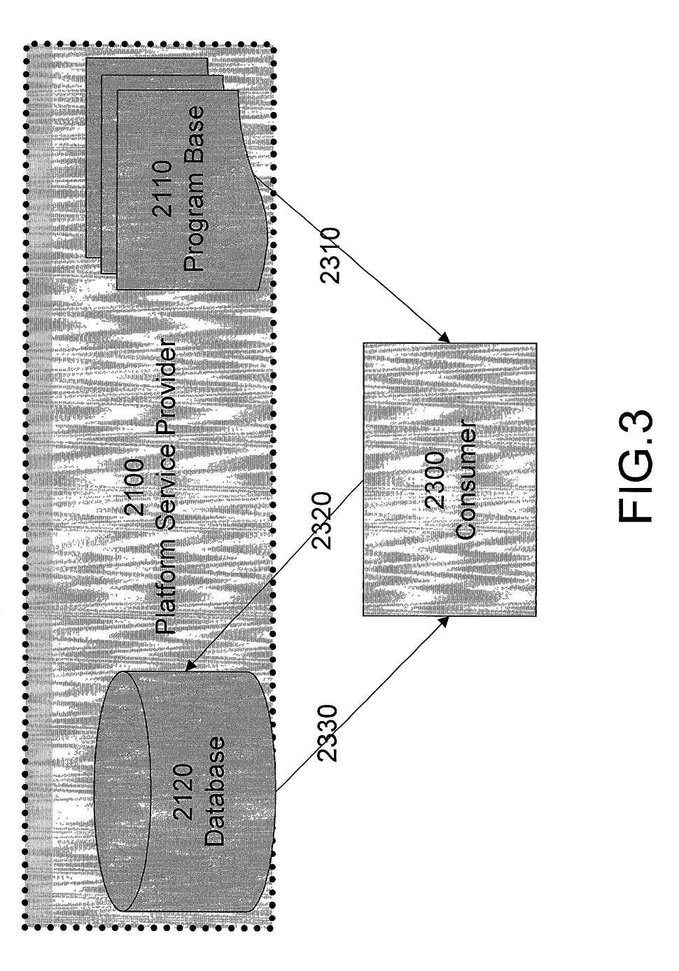

On the other hand, FIG. 3 shows that a consumer 2300 connects to the platform service provider 2100 through the Internet or other types of networks. After the network connection, the consumer has to download and install a search sharing system from the program base 2110 of the platform service provider 2100 (step 2310). After the installation, the consumer 2300 can use this search sharing system to connect to the database 2120 of the platform service provider 2100. A keyword can be sent out through a computer or some network terminal device to the database 2120 to search for desired digital files (step 2320).

The search sharing system uses an algorithm analogous to MD5 to compute the file fingerprint for each of the shared digital files that the consumer 2300 has and uploads the fingerprints to the database 2120 of the platform service provider 2100 for comparison, so that the database 2120 always stores the latest correspondence information of the copyright owner and the file owner. The consumer 2300 can use the searching function and the network connection system of this search sharing system to connect to the database 2120, select the real-time digital file owner information (step 2330), and the file download information.

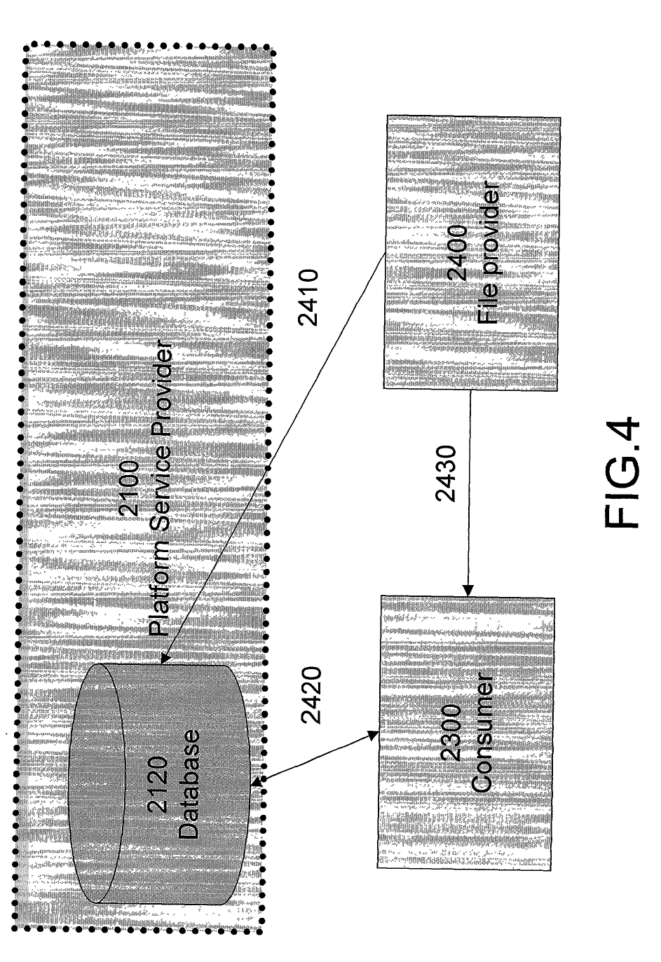

In FIG. 4, the file owner is the file provider, which can be the copyright owner 2200, the platform service provider 2100, or one of the consumers 2300 who has downloaded the file and is willing to share. In step 2410, the file provider 2400 already uploads the information of files to be shared to the database 2120 through the sharing function immediately after the search sharing system is started. Other consumers 2300 search in the database 2120 through the search sharing system in step 2420 and obtain a list of file providers who own the desired files. After the consumer 2300 selects to download and purchase the file from a particular file provider 2400 (step 2430), the consumer 2300 becomes a downloader. The network devices of the downloader is driven by the search sharing system to communicate directly to the devices of the file provider 2400 in the peer-to-peer connecting way. After the connection between the two parties is successful, the file is duplicated and transferred from the search sharing system of the file provider 2400 to that of the consumer 2300, without any bandwidth and system resources from the platform service provider 2100. Furthermore, the downloader, i.e. that consumer 2300, can use a computer or other file processing devices to process and use the downloaded digital file. The consumer can also choose to leave the file in the search sharing system for sharing with other consumers, becoming the role of a file provider 2400.

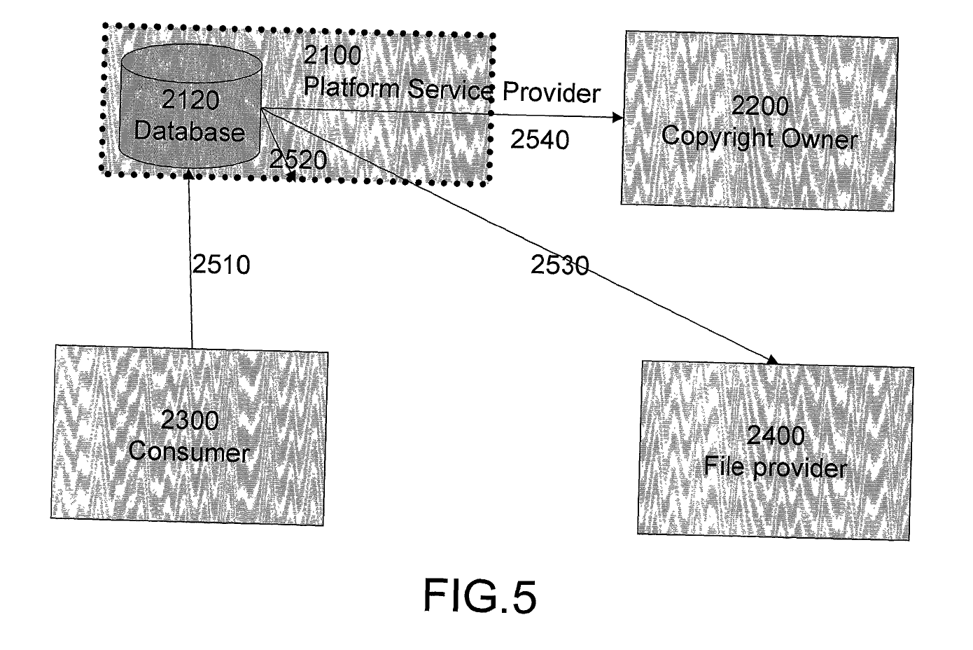

It should be noted that after the downloader succeeds in downloading the digital file, appropriate network points (which can be converted into real currencies or articles) are paid from the downloader to the file provider 2400, the platform service provider 2100 and the copyright owner 2200. As shown in FIG. 5, the consumer 2300 is a downloader. The installed search sharing system continuously detects any download behavior using the computer. Once a digital file is completely downloaded, the system sends out a signal to the database 2120 provided by the platform service provider 2100 through the network, deducting appropriate network points of the consumer 2300 in the database 2120 (step 2510). The system program and the database allots network points in this transaction to the platform service provider 2100 (step 2520), the copyright owner 2200 (step 2540), and the file provider 2400 who provide file download resources and bandwidth (step 2530) in proportion. If the consumer 2300 fails in downloading the file, the search sharing system tries to establish the peer-to-peer network connection to the file provider 2400 again and continues the download until it is successful before the network points are deducted in the database 2120.

Further referring to FIG. 2, if the copyright owner 2200 can use the copyright management system at any time to withdraw a registered digital file from the database 2120 to stop sharing the particular file. After connecting to the database 2120 of the platform service provider 2100 through a computer or analogous computing machine, the copyright owner 2200 can tag the digital file and the file fingerprint as lock so that any consumer 2300 with the search sharing system cannot search, download and share the digital file. It is of no use even if the filename is changed because the invention compares the file fingerprint all the time. As long as the file fingerprint is the same, digital files with different filenames will still be identified and locked.

Moreover, a database table can be designed in the database 2120. The table records fingerprints and relevant data of the locked files. It is designed so that any search sharing system first excludes files with the file fingerprints listed in the table before searching, sharing, and downloading. Therefore, even digital contents yet registered for publication can be effectively protected. The invention prevents the possibility of illegally distributing digital contents without the permission or unlock request from the creator or the copyright owner.

To conclude, the invention has the following advantages:

1. The invention is a digital contents copyright management structure comprising a search sharing system and a copyright management system using computers and related networks.

2. The invention provides a copyright management system to solve the copyright problems of illegally downloading IP's in the digital network era. Furthermore, the invention utilizes an MD5-type algorithm to use file fingerprints for strictly controlling the copyrights of digital contents.

3. The invention provides a simple and low-cost digital contents publication platform for individuals. It does not only solve the conventional problem of higher costs in channels and marketing so that the consumer can obtain desired products at a cheaper price, the rights of the creator and the digital contents industry can be guaranteed with the help of the disclosed copyright control and management mechanism too.

4. The search sharing system of the invention fully utilizes the advantages of the peer-to-peer network connection for the rapid distribution and sale of digital contents without high costs and bandwidth from the copyright owner or the platform service provider.

5. The digital file provider also benefits from sharing files and bandwidth resources. Therefore, the file provider will also help distributing the files for the copyright owner.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A peer-to-peer digital copyright management method, which comprises the steps of:
providing a copyright management system installed on a first digital processing device;
using the operating abilities of the copyright management system and the first digital processing device to generate a file fingerprint for a digital file provided by a copyright owner;
using the network connecting abilities of the copyright management system and the first digital processing device to connect the copyright management system with a copyright database of a platform service provider;
uploading at least a first member account name of the copyright owner, the file fingerprint, the filename of the digital file, and a price to the copyright database for registration;
providing a first search sharing system installed on a second digital processing device of a file provider;
partitioning a data sharing area in the second digital processing device of the file provider so that the file provider can put a plurality of digital files to be shared in the data sharing area;
using the operating abilities of the first search sharing system and the second digital processing device to generate file fingerprints for each of the shared digital files;
uploading at least a second member account name of the file provider, the file fingerprints of the digital files, and the filenames of the digital files to the copyright database for comparing with the registered digital files provided by the copyright owner;
providing a second search sharing system installed on a third digital processing device of a consumer;
using the network connecting abilities of the second search sharing system and the third digital processing device to connect the second search sharing system with the copyright database of the platform service provider;
uploading at least one keyword for searching a digital file interested by the consumer;
returning a search result according to the keyword from the copyright database to the second search sharing system for the consumer to select a source for the digital file;
using the network connecting abilities of the second search sharing system, the third digital processing device, the first search sharing system and the second digital processing device to connect the second search sharing system with the first search sharing system, establishing a peer-to-peer network connection, and downloading the digital file from the first search sharing system to the second search sharing system; and
deducting network points of the consumer in the copyright database and allotting the network points to the member accounts of the copyright owner, the file provider, and the platform service provider in proportion.

2. The method of claim 1, wherein the copyright management system only needs to be installed once and is able to be started at any time afterwards.

3. The method of claim 1, wherein the first digital processing device, the second digital processing device and the third digital processing device are computers.

4. The method of claim 1, wherein the file fingerprint includes a string generated according to the MD5 algorithm.

5. The method of claim 1, wherein the copyright management system comprises a computer software system.

6. The method of claim 1, wherein the network connecting abilities comprises Internet connecting abilities.

7. The method of claim 1, wherein the digital files are computer files.

8. The method of claim 1, wherein the first member account name is a private account of the copyright owner authorized by the platform service provider for tagging the copyright sources of the registered digital files.

9. The method of claim 1, wherein the price is set by the copyright owner.

10. The method of claim 1, wherein the first search sharing system and the second search sharing system are the same and consist of a computer software system.

11. The method of claim 1, wherein the platform service provider offers services from a website center.

12. The method of claim 1, wherein the data sharing area is a computer file folder.

13. The method of claim 1, wherein each of the digital files shared by the file provider is compared with one registered in the copyright database using the file fingerprint data.

14. The method of claim 1, wherein the searching result list is the result filtered out from the database according to the uploaded keyword from the consumer, the result providing the second search sharing system the ability to connect to the first search sharing system of the file provider who owns the digital file satisfying the conditions and to download the digital file.

15. The method of claim 1, wherein the network points are tokens for network transactions that can be cashed at the platform service provider for equivalent currencies.

16. The method of claim 1 further comprising the step of file registration withdrawal, in which the copyright owner uses the copyright management system to withdraw the copyright, preventing the digital file previously registered for sale from being shared and downloaded.

17. The method of claim 1 further comprising the step of locking a digital file, which provides a lock table for registering all fingerprints of the digital files to be shared so that the search sharing systems first check the lock table before searching, sharing and downloading, preventing locked files from being distributed without the permission and unlock from the creator and copyright owner.
